(19) United States
(12) Patent Application Publication
(10) Pub. No.: US 2012/0134813 A1
(43) Pub. Date: May 31, 2012

(54) ACTIVE FLOW CONTROL SYSTEM AND METHOD FOR OPERATING THE SYSTEM TO REDUCE IMBALANCE

(76) Inventors: Jacob Johannes Nies, Zwolle (NL); Wouter Haans, Den Haag (NL)

(21) Appl. No.: 13/324,015

(22) Filed: Dec. 13, 2011

(51) Int. Cl. F03D 7/00

(52) U.S. Cl. 416/1; 416/43

(57) ABSTRACT

A control system for use with a wind turbine is provided. The wind turbine includes a rotor, a blade coupled to the rotor, a sensor configured to obtain a measurement of the wind turbine, and an active flow control system at least partially defined within the blade. The control system is configured to operate the active flow control system in a first mode, receive a signal from the sensor indicating a load imbalance on the rotor, and change an operation of the active flow control system from the first mode to a second mode based on the signal. The second mode is configured to reduce the load imbalance on the rotor.

### BACKGROUND OF THE INVENTION

The embodiments described herein relate generally to an active flow control system for use with a wind turbine and, more particularly, an active flow control system that is operated to reduce imbalance of the wind turbine.

At least some known wind turbines experience aerodynamic imbalance. More specifically, a rotor of and/or loads on a known wind turbine may become imbalanced due to system imbalance or environmental condition imbalance. System imbalance can caused by, but is not limited to being caused by, different weighted blades, variation of weight across one blade, differences caused by manufacturing tolerances in blade geometries, manufacturing differences and/or tolerances in pitch control mechanisms, manufacturing differences and/or tolerances in components of an active flow control (AFC) system, and/or adjustment deviations in the pitch control mechanism and/or the components of the AFC system. For example, if one blade has a pitch control mechanism that operates at a different speed than other blades' pitch control mechanisms, apertures in one blade's AFC system are a different size than another blade's apertures, and/or a flow control device in one blade operates differently than other flow control devices, the rotor and/or loads on the blades may become imbalanced. Further, conditions surrounding the wind turbine may cause imbalance. For example, if one blade becomes more iced or fouled than another blade, the rotor and/or loads may become imbalanced.

At least some known wind turbines include additional weights to address imbalance caused by differences in weight. Further, at least some known wind turbines include blades that are pre-set to a setting that creates a minimum amount of aerodynamic imbalance. Besides primary tasks of adjusting a power intake to match power limitations of a drive train and feathering the blade in a stop, at least some known pitch adjustment systems are configured to reduce imbalance of the rotor and/or loads on the blades. However, the pitch adjustment system is also configured to perform a plurality of other tasks each having a target, such as optimizing a power generated by the wind turbine, reducing a load on a blade and/or other components of the wind turbine, and/or reducing noise produced by the wind turbine. Because the known pitch adjustment system can only achieve an optimum for a limited number of targets simultaneously, the targets are prioritized and a higher priority target is performed when there are conflicting targets for the pitch adjustment system to perform. As such, known pitch adjustment systems may not address imbalance in order to achieve a higher priority target.

### BRIEF DESCRIPTION OF THE INVENTION

In one aspect, a control system for use with a wind turbine is provided. The wind turbine includes a rotor, a blade coupled to the rotor, a sensor configured to obtain a measurement of the wind turbine, and an active flow control system at least partially defined within the blade. The control system is configured to operate the active flow control system in a first mode, receive a signal from the sensor indicating a load imbalance on the rotor, and change an operation of the active flow control system from the first mode to a second mode based on the signal. The second mode is configured to reduce the load imbalance on the rotor.

In another aspect, a wind turbine is provided. The wind turbine includes a rotor, at least one sensor configured to obtain a measurement of the wind turbine, at least one blade coupled to the rotor, wherein the blade has an outer surface, and an air distribution system at least partially defined within the blade. The air distribution system includes at least one aperture defined through the outer surface of the blade. A control system is in operational control communication with the at least one sensor and the air distribution system. The control system is configured to operate the air distribution system in a first mode, receive a signal from the sensor indicating a load imbalance on the rotor, and change an operation of the air distribution system from the first mode to a second mode based on the signal. The second mode is configured to reduce the load imbalance on the rotor.

In yet another aspect, a method of operating a wind turbine is provided. The wind turbine includes a rotor, a plurality of blades coupled to the rotor, and an active flow control system at least partially defined within each of the plurality of blades. The method includes operating the active flow control system in a first mode, obtaining a signal from a sensor that indicates a load imbalance on the rotor, and changing an operation of the active flow control system from the first mode to a second mode based on the signal. The second mode is configured to reduce the load imbalance on the rotor.

### BRIEF DESCRIPTION OF THE DRAWINGS

FIGS. 1-5 show exemplary embodiments of the systems and methods described herein.

FIG. 1 is a perspective view of an exemplary wind turbine.

FIG. 2 is a schematic view of an exemplary flow control system that may be used with the wind turbine shown in FIG. 1.

FIG. 3 is a schematic view of an exemplary alternative flow control system that may be used with the wind turbine shown in FIG. 1.

FIG. 4 is an enlarged cross-sectional view of a portion of the flow control system shown in FIG. 3.

FIG. 5 is a flowchart of an exemplary method for operating a wind turbine that may include a flow control system shown in FIG. 2 or 3.

### DETAILED DESCRIPTION OF THE INVENTION

The active flow control (AFC) systems described herein enhance lift properties of a blade, but an AFC response will differ from blade to blade due to manufacturing and/or operational differences within the AFC system. The herein-described embodiments correct and/or reduce aerodynamic imbalance caused by a plurality of sources, such as weight, dimensions, vibrations, adjustment deviations, flow rates in an AFC system, geometrical differences in the AFC system, and/or different behavior of the AFC system over an incoming wind field. As used herein, the term “imbalance” refers to a primary aspect of a force or a moment rotating with a rotor, as well as the effects of imbalance, such as a change in driving torque or changes in a pattern of motion.

The embodiments described herein use an AFC system of a wind turbine to reduce imbalance of a rotor and/or loads on blades of a wind turbine. More specifically, a pressure in the AFC system and/or distribution of air within the AFC system is controlled to reduce imbalance from any source of imbalance. For example, a bending and/or deflection of the rotor is measured and the AFC system is controlled based on the measurement. As such, a number of tasks or targets performed by a pitch adjustment system is reduced, and an imbalance task is transferred to the AFC system. Further, imbalance can be counteracted by changing a strength of AFC response, as well as by using conventional techniques.

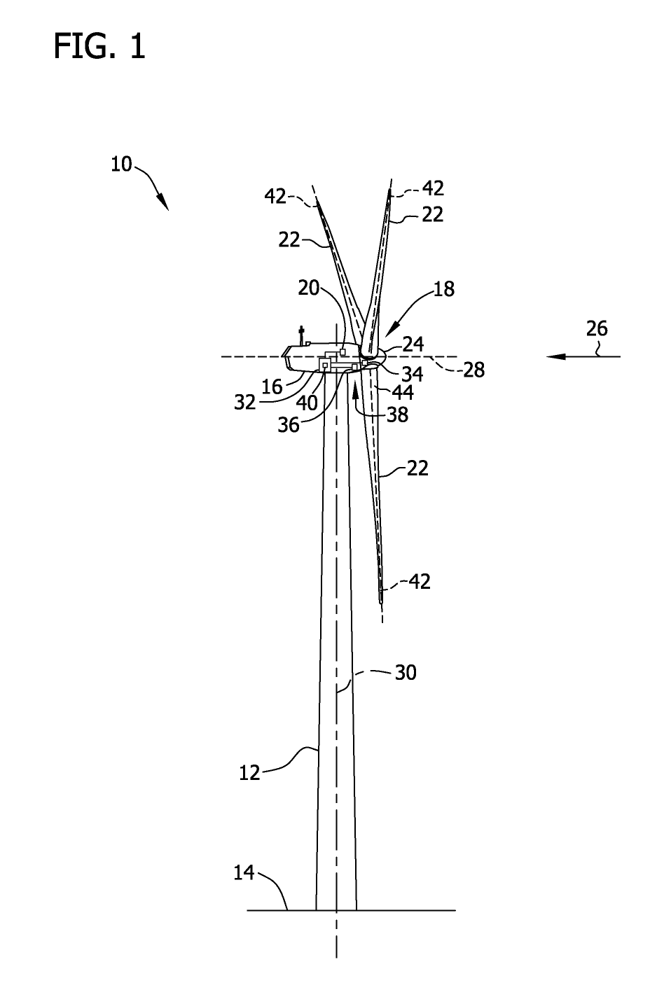

FIG. 1 is a perspective view of an exemplary wind turbine 10. In the exemplary embodiment, wind turbine 10 is a nearly horizontal-axis wind turbine. In another embodiment, wind turbine 10 may have any suitable tilt angle. Alternatively, wind turbine 10 may be a vertical axis wind turbine. In the exemplary embodiment, wind turbine 10 includes a tower 12 that extends from a supporting surface 14, a nacelle 16 mounted on tower 12, and a rotor 18 that is coupled to nacelle 16. In the exemplary embodiment, tower 12 is fabricated from tubular steel such that a cavity (not shown in FIG. 1) is defined between supporting surface 14 and nacelle 16. In an alternative embodiment, tower 12 is any suitable type of tower. A height of tower 12 is selected based upon factors and conditions known in the art.

At least one sensor 20 is configured to obtain a measurement indicating imbalance and transmit a signal of the measurement. For example, sensor 20 can measure a blade root bending, hub stresses and/or strains, bending moments in rotating and static systems, a bearing position, a deflection of flexible elements, and/or a position, a velocity, and/or an acceleration of components of wind turbine 10. Such measurements are indicative of imbalance of aerodynamic loading on blades 22. In the exemplary embodiment, at least one sensor 20 is coupled to and/or positioned adjacent to rotor 18 and is configured to measure bending and/or deflection of rotor 18. In a particular embodiment, sensors 20 are coupled to a flange in front of a main bearing. In the exemplary embodiment, sensor 20 can be any suitable sensor, such as a stress sensor, a strain sensor, a magnetic sensor, an inductive sensor, a capacitive sensor, and/or a magnetostrictive sensor, that measures, senses, and/or detects bending of rotor 18 and/or any other suitable component of wind turbine 10. The bending and/or deflection of rotor 18 indicates uneven loading of blades 22, which causes imbalance of rotor 18 and/or imbalance of loads on blades 22.

Rotor 18 further includes a rotatable hub 24 and at least one blade 22 coupled to and extending outward from hub 24. As used herein, the term “coupled” with reference to blade 22 and rotor 18 is intended to describe a blade 22 that is attached to rotor 18 and/or a blade 22 that is formed integrally as one piece with rotor 18. In the exemplary embodiment, rotor 18 has three blades 22. In an alternative embodiment, rotor 18 includes more or less than three blades 22. In the exemplary embodiment, blades 22 are spaced about hub 24 to facilitate rotating rotor 18 to enable kinetic energy to be transferred from the wind into usable mechanical energy, and subsequently, electrical energy.

In the exemplary embodiment, blades 22 have a length of between approximately 30 meters (m) (99 feet (ft)) and approximately 120 m (394 ft). Alternatively, blades 22 may have any length that enables wind turbine 10 to function as described herein. As wind strikes blades 22 from a direction 26, rotor 18 is rotated about an axis of rotation 28. As blades 22 are rotated and subjected to centrifugal forces, blades 22 are also subjected to various forces and moments. Further, in the exemplary embodiment, as direction 26 changes, a yaw direction of nacelle 16 may be controlled about a yaw axis 30 to position blades 22 with respect to direction 26.

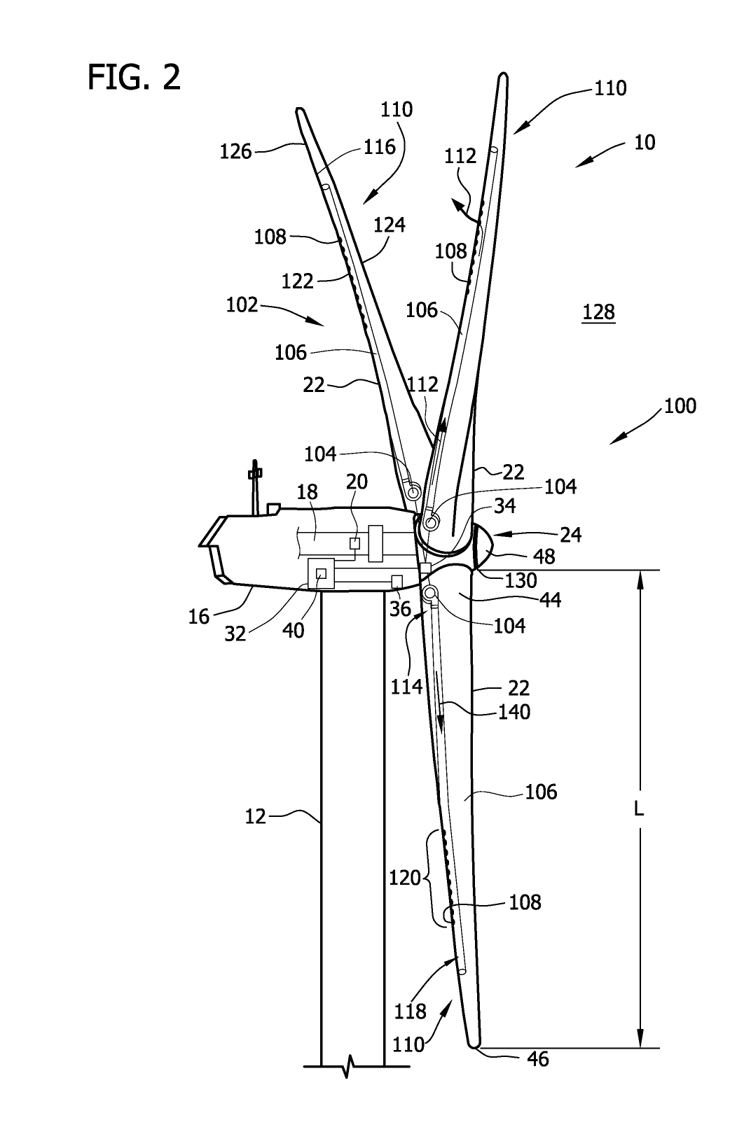

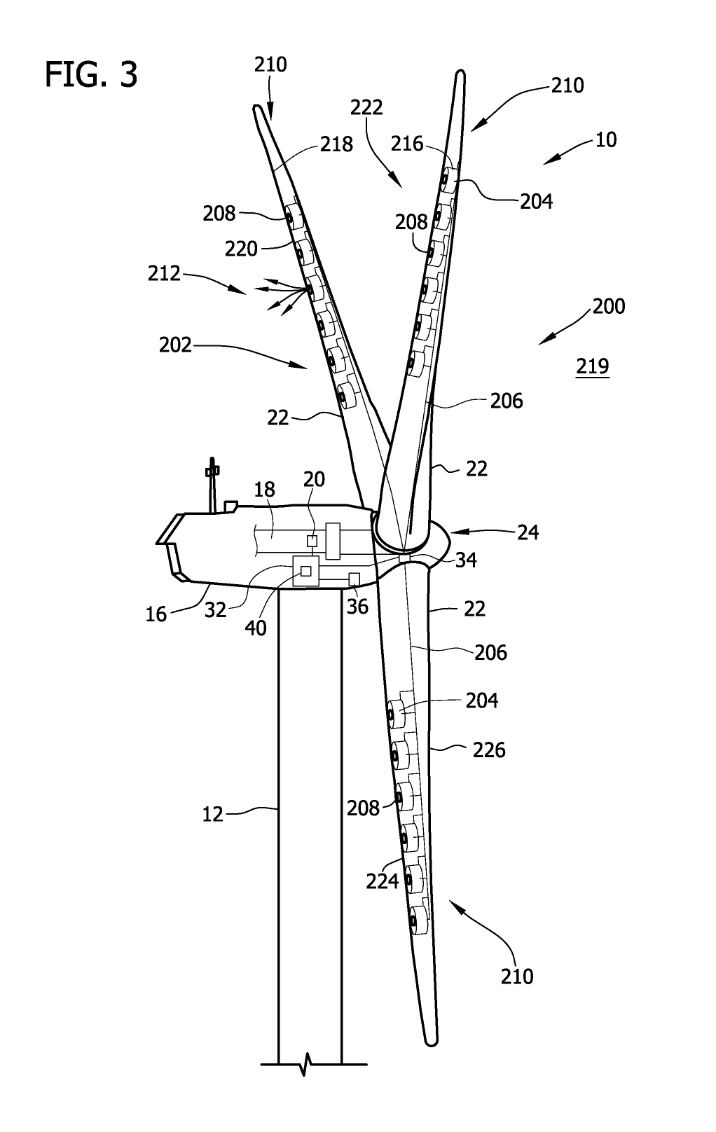

Wind turbine 10 includes a control system 32. Control system 32 is configured control other controllers described herein, such as an AFC controller 34 and/or a pitch controller 36, as well as additional wind turbine controllers not specifically described herein. Control system 32 can be configured to determine which controller is best suited to perform a predetermined action and control that controller to perform the action. In the exemplary embodiment, control system 32 is shown as being centralized within nacelle 16, however control system 32 may be a distributed system throughout wind turbine 10, on supporting surface 14, within a wind farm, and/or at a remote control center. In the exemplary embodiment, a separate controller 34 is included in control system 32 for an AFC system within wind turbine 10, such as flow control system 100 (shown in FIG. 2) and/or flow control system 200 (shown in FIG. 3). Further, control system 32 includes pitch controller 36 for a pitch control system within wind turbine 10, such as a pitch adjustment system 38. In the exemplary embodiment, control system 32 includes sensor 20. More specifically, sensor 20 is coupled in communication with at least pitch controller 36 and flow controller 34 of control system 32.

Control system 32 includes at least one processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels may include, without limitation, sensors and/or computer peripherals associated with an operator interface, such as a mouse and a keyboard. Further, in the exemplary embodiment, output channels may include, without limitation, a control device, an operator interface monitor, and/or a display.

Processors and/or controllers described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a PLC cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, flow control system control commands and/or pitch adjustment control commands. The execution of sequences of instructions is not limited to any specific combination of hardware circuitry and software instructions.

A pitch angle of blades 22, i.e., an angle that determines a perspective of blades 22 with respect to a rotor plane, may be adjusted for a pitch offset. Pitch offset occurs when a reference mark of blade 22 is not exactly positioned at 0° of an aerodynamic profile of blade 22. For example, the reference mark may be off by less than 1° in either direction. Pitch controller 36 is configured to account for the pitch offset of each blade 22. For example, when the reference mark of blade 22 is off by +0.5°, pitch controller 36 is programmed to set a zero reference as +0.5°. As such, pitch controller 36 described herein is configured to account for imbalance caused by inaccuracy of the reference marks of blades 22. Once pitch offsets are accounted for, pitch controller 36 does not need to be reconfigured, unless a blade 22 is replaced.

Further, the pitch angles of blades 22 are changed by pitch adjustment system 38. Pitch adjustment system 38 includes pitch controller 36 and is configured to control power, load, and/or noise generated by wind turbine 10 by adjusting an angular position of a profile of at least one blade 22 relative to wind vectors. Pitch axes 42 for blades 22 are illustrated. In the exemplary embodiment, a pitch of each blade 22 is controlled individually by control system 32. Alternatively, the blade pitch for all blades 22 may be controlled simultaneously by control system 32. In the exemplary embodiment, pitch controller 36 is configured to achieve a plurality of targets, such as maximizing energy capture, maintaining loads of wind turbine components in an optimum range and pattern, and operating within noise restrictions.

To perform at least one task, pitch adjustment system 38 changes a pitch of at least one blade 22 by rotating blade 22 about a respective pitch axis 42. In the exemplary embodiment, the pitch of at least one blade 22 is continuously adjusted at a first rate, such as 10 adjustments per second or a frequency of about 10 Hertz (Hz). When making pitch adjustments to blades 22, pitch adjustment system 38 accounts for pitch offset as described herein. Although, the AFC system of wind turbine 10 is configured to correct and/or reduce imbalance, pitch controller 36 is also configured to correct and/or reduce imbalance. However, the imbalance tasks can be at a low priority in pitch controller 36 such that pitch controller 36 can perform other tasks while the AFC system performs the imbalance task. Alternatively, the AFC system can perform other tasks while pitch controller 36 performs the imbalance task.

FIG. 2 is a schematic view of an exemplary flow control system 100 that may be used with wind turbine 10. In the exemplary embodiment, flow control system 100 is a nonzero-net-mass flow control system that includes an air distribution system 102. Flow controller 34 of control system 32 is considered to be a component of flow control system 100 and is in operational control communication with air distribution system 102. As used herein, “operational control communication” refers to a link, such as a conductor, a wire, and/or a data link, between two or more components of wind turbine 10 that enables signals, electric currents, and/or commands to be communicated between the two or more components. The link is configured to enable one component to control an operation of another component of wind turbine 10 using the communicated signals, electric currents, and/or commands.

Air distribution system 102 includes at least one flow control device 104, at least one manifold 106, and at least one aperture 108. At least one flow control device 104, a respective manifold 106, and one or more corresponding apertures 108 form an assembly 110. Each blade 22 includes an assembly 110 at least partially defined therein. As such, air distribution system 102 includes a plurality of flow control devices 104, a plurality of manifolds 106, and a plurality of apertures 108. Alternatively, at least one blade 22 includes an assembly 110. In the exemplary embodiment, each assembly 110 is substantially similar, however, at least one assembly 110 may be different than at least one other assembly 110. Further, although in the exemplary embodiment each assembly 110 includes a flow control device 104, at least two assemblies 110 may share a common flow control device 104.

Flow control device 104 is, for example, a pump, a compressor, a fan, a blower, and/or any other suitable device for controlling a flow of a fluid. In one embodiment, flow control device 104 and/or assembly 110 includes a valve (not shown) that is configured to regulate a flow within air distribution system 102, such as a flow rate and/or a flow direction. In the exemplary embodiment, flow control device 104 is reversible for changing a direction of a fluid flow 112. Further, in the exemplary embodiment, air distribution system 102 includes one flow control device 104 for each blade 22 of wind turbine 10, however, it should be understood that air distribution system 102 can include any suitable number of flow control devices 104. Flow controller 34 is in operational control communication with each flow control device 104 for controlling fluid flows through air distribution system 102. Flow controller 34 may be directly coupled in operational control communication with each flow control device 104 and/or may be coupled in operational control communication with each flow control device 104 via a communication hub and/or any other suitable communication device(s).

Each flow control device 104 is in flow communication with at least one manifold 106. When one centralized flow control device 104 is used, flow control device 104 is in flow communication with each manifold 106 of air distribution system 102. In the exemplary embodiment, a flow control device 104 is coupled within a respective blade 22 at a root end 114 of each manifold 106 and/or a root portion 44 of each blade 22. Alternatively, flow control device 104 may be in any suitable position within wind turbine 10 and/or on supporting surface 14 (shown in FIG. 1) with respect to at least one manifold 106.

In the exemplary embodiment, each manifold 106 is at least partially defined along an interior surface 116 within respective blade 22 and extends generally along a respective pitch axis 42 (shown in FIG. 1) from root end 114 of manifold 106 to a tip end 118 of manifold 106. It should be understood that tip end 118 is not necessarily positioned within a tip 46 of blade 22, but rather, is positioned nearer to tip 46 than manifold root end 114 is. In one embodiment, apertures 108 are defined at a predetermined portion 120 of a length L of blade 22 from root end 114 within tip end 118. Further, it should be understood that manifold 106 may have any suitable configuration, cross-sectional shape, length, and/or dimensions that enables air distribution system 102 and/or flow control system 100 to function as described herein. It should also be understood that one or more components of blade 22 can be used to form manifold 106.

In the exemplary embodiment, air distribution system 102 also includes at least one aperture 108 in flow communication with respective manifold 106. More specifically, in the exemplary embodiment, air distribution system 102 includes a plurality of apertures 108 defined along a suction side 122 of respective blade 22. Although apertures 108 are shown as being aligned in a line along suction side 122, it should be understood that apertures 108 may be positioned anywhere along suction side 122 of blade 22 that enables flow control system 100 to function as described herein. Alternatively or additionally, apertures 108 are defined through a pressure side 124 of blade 22. In the exemplary embodiment, aperture 108 is defined through an outer surface 126 of blade 22 for providing flow communication between manifold 106 and ambient air 128.

Flow control devices 104 are, in the exemplary embodiment, in flow communication with ambient air 128 via an opening 130 defined between hub 24 and a hub cover 48. Alternatively, wind turbine 10 does not include hub cover 48, and ambient air 128 is drawn into air distribution system 102 through an opening 130 near hub 24. In the exemplary embodiment, flow control devices 104 are configured to draw in ambient air 128 through opening 130 and to discharge fluid flow 112 generated from ambient air 128 into respective manifold 106. Alternatively, opening 130 may be defined at any suitable location within hub 24, nacelle 16, blade 22, tower 12, and/or auxiliary device (not shown) that enables air distribution system 102 to function as described herein. Further, air distribution system 102 may include more than one opening 130 for drawing air into air distribution system 102, such as including one opening 130 for each flow control device 104. In an alternative embodiment, a filter is included within opening 130 for filtering air 128 entering air distribution system 102. It should be understood that the filter referred to herein can filter particles from a fluid flow and/or separate liquid from the fluid flow.

During a flow control operation, flow control system 100 is used to provide AFC for wind turbine 10. More specifically, flow controller 34 controls air distribution system 102 to draw in ambient air 128 and discharge a fluid flow 112 through at least one aperture 108. Operation of one assembly 110 will be described herein, however, it should be understood that in one embodiment each assembly 110 functions similarly. Further, assemblies 110 can be controlled to operate in substantial synchronicity and/or each assembly 110 may be controlled separately such that a fluid flow about each blade 22 may be manipulated separately. When assemblies 110 are controlled in synchronicity, flow control system 100 can be controlled by flow controller 34 to maintain a target value(s) for load spectrum, power level, noise level, and/or imbalance correction. In the exemplary embodiment, flow controller 34 controls flow control device 104 to draw in ambient air 128 to generate fluid flow 112 having one or more predetermined parameters, such as a velocity, a mass flow rate, a pressure, a temperature, and/or any suitable flow parameter. Flow control device 104 channels fluid flow 112 through manifold 106 from root end 114 to tip end 118. It should be understood that any suitable control methods and/or components, such as pitching blade(s) 22, can alternatively or additionally be used to control a load spectrum, a power level, and/or a noise level of wind turbine 10.

As fluid flow 112 is channeled through manifold 106, fluid flow 112 is discharged from air distribution system 102 and flow control system 100 through apertures 108. Discharged fluid flow 112 facilitates manipulating at least a boundary layer of a fluid flow across outer surface 126 of blade 22. More specifically, discharging fluid flow 112 at suction side 122 of blade 22 increases the lift on blade 22, which increases the power generated by wind turbine 10. In a particular embodiment, fluid flow 112 is discharged from apertures 108 to reduce an aerodynamic imbalance on blade(s) 22, as described in more detail below. Alternatively, flow control device 104 may be operated to draw in ambient air 128 through apertures 108 into manifold 106 for discharge from nacelle 16, hub 24, and/or any other suitable location. As such, ambient air 128 is drawn in from the boundary layer to manipulate the boundary layer.

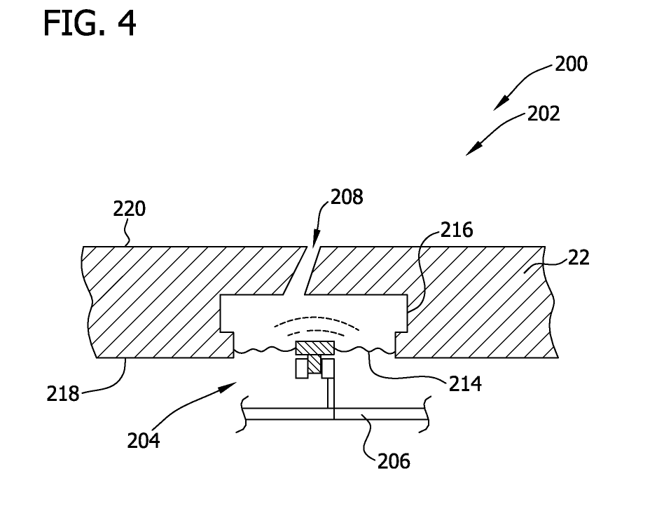

FIG. 3 is a schematic view of an exemplary alternative flow control system 200 that may be used with wind turbine 10. FIG. 4 is an enlarged cross-sectional view of a portion of flow control system 200. Components shown in FIG. 1 are labeled with similar reference numbers in FIGS. 3 and 4. In the exemplary embodiment, flow control system 200 is a zero-net-mass flow control system that includes an air distribution system 202. Flow controller 34 is considered to be a component of flow control system 200 and is in operational control communication with air distribution system 202.

Air distribution system 202 includes at least one actuator 204, at least one communication link 206, and at least one aperture 208. Actuator 204, communication link 206, and apertures 208 define an assembly 210. In the exemplary embodiment, each blade 22 includes a respective assembly 210. As such, in the exemplary embodiment, air distribution system 202 includes a plurality of actuators 204, communication links 206, and apertures 208. Alternatively, air distribution system 202 includes one common communication link 206 for assemblies 210. In an alternative embodiment, at least one blade 22 includes an assembly 210 having communication link 206. In one embodiment, communication link 206 provides operational control communication between flow controller 34 and at least one actuator 204. In the exemplary embodiment, communication link 206 provides operational control communication between flow controller 34 and a plurality of actuators 204 within an assembly 210. Communications links 206 may be directly coupled in communication with flow controller 34 and/or in communication with flow controller 34 via a communications hub and/or any other suitable communication device. In one embodiment, actuator 204, communication link 206, and/or aperture 208 are at least partially defined in blade 22.

Actuator 204 is, in the exemplary embodiment, any known or contemplated actuator configured to form a synthetic jet 212 of fluid. As used herein, the term “synthetic jet” refers to a jet of fluid that is created by cyclic movement of a diaphragm and/or piston 214, where the jet flow is synthesized from the ambient fluid. Synthetic jet 212 may be considered a fluid flow through flow control system 200. In one embodiment, actuator 204 includes a housing 216 and diaphragm and/or a piston 214 within housing 216. Diaphragm and/or piston 214 can be mechanically, piezoelectrically, pneumatically, magnetically, and/or otherwise controlled to form synthetic jet 212. In the exemplary embodiment, actuator 204 is coupled to an interior surface 218 of blade 22 and is aligned with aperture 208 such that synthetic jet 212 and/or ambient air 219 flows through aperture 208.

Aperture 208 is defined within blade 22, and, more specifically, through an outer surface 220 of blade 22. Further, in the exemplary embodiment, at least one assembly 210 of air distribution system 202 includes a plurality of actuators 204 and a plurality of apertures 208. As such, air distribution system 202 includes an array 222 of apertures 208 defined through blade 22. In the exemplary embodiment, apertures 208 are defined along a suction side 224 of each blade 22. Although apertures 208 and/or actuators 204 are shown as being aligned in a line along suction sides 224, it should be understood that apertures 208 and/or actuators 204 may be positioned anywhere along suction side 224 of blade 22 that enables flow control system 200 to function as described herein. Additionally or alternatively, apertures 208 are defined through a pressure side 226 of blade 22, and/or actuators 204 are coupled to interior surface 218 of any suitable side of blade 22. In the exemplary embodiment, aperture 208 is configured to provide flow communication between a respective actuator housing 216 and ambient air 219.

During a flow control operation, flow control system 200 is used to provide AFC for wind turbine 10. More specifically, flow controller 34 controls air distribution system 202 to draw in ambient air 219 and generate synthetic jet 212 through at least one aperture 208. Operation of one assembly 210 will be described herein, however, it should be understood that each assembly 210 functions similarly. Further, assemblies 210 can be controlled to operate in substantial synchronicity and/or each assembly 210 may be controlled separately such that a fluid flow about each blade 22 may be manipulated separately. When assemblies 210 are controlled in synchronicity, flow control system 200 can be controlled by flow controller 34 to maintain a target value(s) for load spectrum, power level, noise level, and/or imbalance correction. In a particular embodiment, synthetic jet 212 is discharged from apertures 208 to reduce an aerodynamic imbalance on blade(s) 22, as described in more detail below.

In the exemplary embodiment, flow controller 34 instructs actuator 204 to alternately draw ambient air 219 into housing 216 (also referred to herein as a “breath-in stroke”) and discharge synthetic jet 212 (also referred to herein as a “breath-out stroke”) from housing 216 using diaphragm and/or piston 214 to generate synthetic jet 212 having one or more predetermined parameters, such as a velocity, a mass flow rate, a pressure, a temperature, and/or any suitable flow parameter. Synthetic jets 212 facilitate manipulating at least a boundary layer of a fluid flow across outer surface 220 of blade 22. More specifically, discharging synthetic jets 212 at suction side 224 of blade 22 increases the lift on blade 22, which increases the power generated by wind turbine 10. In a particular embodiment, discharging synthetic jets 212 at suction side 224 of blade 22 reduces an imbalance of loads on blades 22.

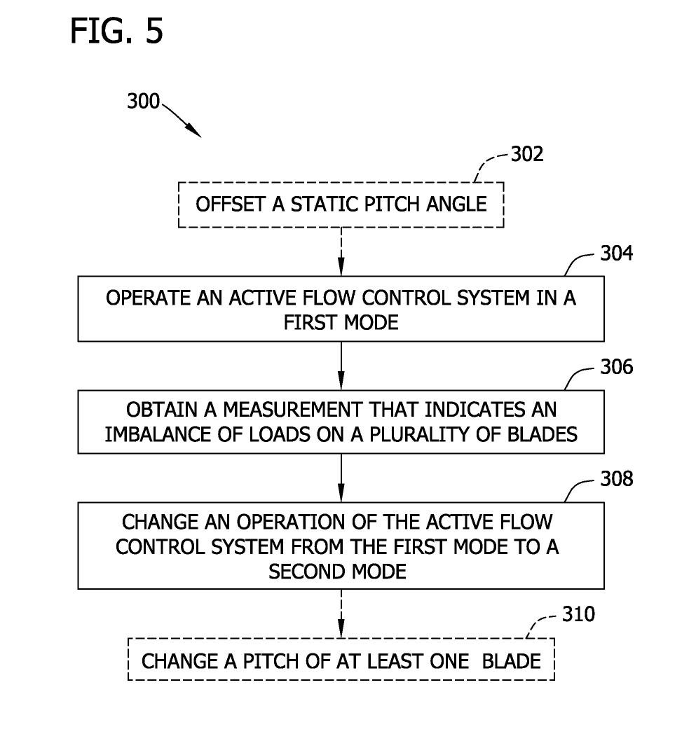

FIG. 5 is a flowchart of a method 300 for operating wind turbine 10 (shown in FIG. 1). By performing method 300, imbalanced aerodynamic loading on wind turbine 10 is facilitated to be corrected and/or reduced. Method 300 is performed by control system 32 (shown in FIG. 1) sending signals, commands, and/or instructions to components of wind turbine 10, such as pitch adjustment system 38 (shown in FIG. 1), air distribution system 102 and/or 202 (shown in FIGS. 2 and 3), and/or any suitable component. Processor 40 (shown in FIG. 1) within control system 32 is programmed with code segments configured to perform method 300. Alternatively, method 300 is encoded on a computer-readable medium that is readable by control system 32. In such an embodiment, control system 32, processor 40, pitch controller 36 (shown in FIG. 1), and/or flow controller 34 (shown in FIG. 1) is configured to read computer-readable medium for performing method 300.

In the exemplary embodiment, method 300 is performed periodically according to a predetermined frequency. In a particular embodiment, control system 32 performs method 300 after control system 32 and/or a human operator determines an aerodynamic imbalance is occurring. Method 300 uses a feed forward loop and/or signal to optimize static pitch offsets and a flow control system to correct and/or reduce imbalance. More specifically, an operating parameter of the flow control system is continuously changed as rotor 18 (shown in FIG. 1) rotates to facilitate balancing aerodynamic loading on wind turbine 10. For example, control system 32 changes a pressure level with the flow control system, switches sections of the flow control system on and off, and/or controls power to a flow control device, distributing distribution in a manifold. The flow control system can space-wise and/or time-wise adjust an AFC variable by adjusting flow restrictions of components of the flow control system. Method 300 can further use pitch-offset-angle fixed values, continuously updated pitch offsets, and/or continuous pitching, in addition to controlling the flow control system, to correct and/or reduce imbalance. In a particular embodiment, pitch adjustments are performed more frequently than AFC adjustments. When method 300 is performed with flow control system 200, AFC adjustments can be made by setting target values, also referred to as set values, for several actuators 204. The rate at which the set values are refreshed can differ depending on the type of actuator 204.

In the exemplary embodiment, control system 32 adjusts the operating parameters of the flow control system at a second rate that is slower than the first rate used to control pitch adjustment system 38. In the exemplary embodiment, the flow control system is adjusted at a predetermined rate or frequency of, for example, once per second or a frequency of about 1 Hz. As such, the flow control system can be adjusted to account for a slowly increasing imbalance, such as icing and/or fouling of the flow control system. Although method 300 is described below with respect to flow control system 100, it should be understood that method 300 can also be used with flow control system 200.

Referring to FIGS. 1, 2, and 5, in one embodiment when nonzero-net-mass flow control system 100 is used within wind turbine 10, method 300 includes offsetting 302 a pitch of each blade 22 based on respective reference mark. When the reference mark of blade 22 is accurate, the pitch of blade 22 is not statically offset 302. When a pitch of blade 22 is statically offset 302, control system 32 is configured to account for an amount of offset 302.

During operation of wind turbine 10, flow control system 100 and/or air distribution system 102 is operated 304 in a first mode. More specifically, the first mode can be any suitable mode for operating flow control system 100 and/or air distribution system 102. For example, flow control system 100 is operated 304 to optimize lift on at least one blade 22 and/or reduce or increase a load on at least one blade 22 in the first mode of operation. In the exemplary embodiment, flow control system 100 is operated to have a first distribution of air within flow control system 100 and/or air distribution system 102 in the first mode.

Control system 32 obtains 306 a signal that indicates an imbalance of loads on blades 22. More specifically, sensor 20 acquires the measurement and transmits the measurement as the signal to control system 32 while flow control system 100 is operating in any suitable mode, such as the first mode. In one embodiment, the measurement is a measurement of a bending moment of rotor 18. In the exemplary embodiment, control system 32 substantially continuously obtains 306 the measurement signal from sensor 20 such that, as the loads on blades 22 change, control system 32 substantially continuously obtains 306 an updated measurement signal from sensor 20. For example, control system 32 receives a continuously variable signal and/or a periodic signal from sensor 20 indicating the measurement.

Based on the obtained 306 measurement signal, control system 32 changes 308 an operation of flow control system 100 from the first mode to a second mode that is configured to reduce the imbalance of the loads on blades 22. As used herein, the term “operation” with respect to flow control system 100 refers to any suitable operation and/or operational parameter of flow control system 100, such as, but not limited to, a pressure level, a flow velocity, a flow rate, a flow direction, and/or a flow or air distribution. In a particular embodiment, flow control system 100 and/or air distribution system 102 is operated to have a second distribution of air that is different than the first distribution of air.

When sensor 20 measures a bending moment of rotor 18, flow control system 100 is operated in a second mode that compensates for the bending moment of rotor 18. In the exemplary embodiment, the operation of flow control system 100 is changed at a first rate, such as 1 Hz. When control system 32 obtains 306 a substantially continuous measurement, flow control system 100 is iteratively changed 308 as the measurement changes. For example, control system 32 uses a feed forward control of flow control system 100 based on the obtained 306 measurement. Using the variable measurement signal, control system 32 can determine whether the imbalance has been reduced.

In the exemplary embodiment, pitch adjustment system 38 is configured to change 310 a pitch of at least one blade 22 to reduce the imbalance of the loads. However, such a task may have a lower priority in pitch adjustment system 38 described herein as compared to known pitch adjustment systems. For example, if other higher priority tasks have been performed and/or targets achieved, pitch adjustment system 38 changes the pitch of blade 22 to reduce the imbalance. In the exemplary embodiment, pitch adjustment system 38 changes 310 the pitch of blade 22 at a second rate that is faster than the second rate. For example, pitch adjustment system 38 changes 310 the pitch of blade 22 at 10 Hz. Pitch adjustment system 38 changes 310 the pitch of blade 22 before, during, and/or after control system 32 changes the operation of flow control system 100. When control system 32 uses a feed forward control loop and/or signal of flow control system 100, control system 32 also uses the feed forward control loop and/or signal to optimize a pitch angle of each blade 22.

The above-described embodiments provide an active flow control (AFC) system that compensates for not only imbalance caused by the AFC system itself, but for imbalance caused by other sources. As such, the AFC system described herein self-adjusts for any imperfections in the AFC system. Further, by using the AFC system to compensate for imbalance, the pitch adjustment system is given an extra degree of freedom extra to achieve optimizations that are not possible for known pitch control systems.

A technical effect of the systems and methods described herein includes at least one of: (a) operating an active flow control system in a first mode; (b) obtaining a signal from a sensor that indicates a load imbalance on a rotor; (c) changing an operation of the active flow control system from the first mode to a second mode based on the signal, wherein the second mode is configured to reduce the load imbalance one the rotor; and (d) changing a pitch of at least one blade of the plurality of blades to reduce the load imbalance.

Exemplary embodiments of an active flow control (AFC) system and method for operating the AFC system to reduce imbalance are described above in detail. The methods and systems are not limited to the specific embodiments described herein, but rather, components of systems and/or steps of the methods may be utilized independently and separately from other components and/or steps described herein. For example, the methods may also be used in combination with other active flow control systems and methods, and are not limited to practice with only the wind turbine systems and methods as described herein. Rather, the exemplary embodiment can be implemented and utilized in connection with many other load-balancing applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A control system for use with a wind turbine including a rotor, a blade coupled to the rotor, a sensor configured to obtain a measurement of the wind turbine, and an active flow control system at least partially defined within the blade, said control system configured to:
operate the active flow control system in a first mode;
receive a signal from the sensor indicating a load imbalance on the rotor; and
change an operation of the active flow control system from the first mode to a second mode based on the signal, the second mode configured to reduce the load imbalance on the rotor.

2. A control system in accordance with claim 1 further configured to iteratively change the operation of the active flow control system based on measurements acquired by the sensor.

3. A control system in accordance with claim 1 further configured to:
obtain a measurement of a bending moment of the rotor; and
operate the active flow control system to compensate for the bending moment of the rotor.

4. A control system in accordance with claim 1 further configured to operate the active flow control system to have a first distribution of air within the active flow control system in the first mode and to have a second distribution of air that is different than the first distribution of air in the second mode.

5. A control system in accordance with claim 1 configured to change a pitch of at least one blade of the plurality of blades to reduce the imbalance of the loads, the pitch changed at a rate that is different than a rate of the change of the active flow control system.

6. A wind turbine comprising:
a rotor;
at least one sensor configured to obtain a measurement of said wind turbine;
at least one blade coupled to said rotor, said blade having an outer surface;
an air distribution system at least partially defined within said blade, said air distribution system comprising at least one aperture defined through said outer surface of said blade; and
a control system in operational control communication with said at least one sensor and said air distribution system, said control system configured to:
operate said air distribution system in a first mode;
receive a signal from said sensor indicating a load imbalance on said rotor; and
change an operation of said air distribution system from the first mode to a second mode based on the signal, the second mode configured to reduce the load imbalance on said rotor.

7. A wind turbine in accordance with claim 6 wherein said at least one sensor comprises at least one of stress sensor, a strain sensor, a magnetic sensor, an inductive sensor, a capacitive sensor, and a magnetostrictive sensor.

8. A wind turbine in accordance with claim 6 wherein said at least one sensor is configured to measure a bending moment of said rotor, and said control system is configured to operate said air distribution system to compensate for the bending moment of said rotor.

9. A wind turbine in accordance with claim 6 wherein the measurement is at least one of a blade root bending measurement, a hub stress measurement, a bending moment rotation in rotating and static systems, a bearing position measurement, a deflection measurement, a position measurement of components of said wind turbine, a velocity measurement of components of said wind turbine, and an acceleration measurement of components of said wind turbine.

10. A wind turbine in accordance with claim 6 wherein said control system is configured to use a feed forward control to optimize static pitch offsets and to reduce the load imbalance using said air distribution system.

11. A wind turbine in accordance with claim 6 further comprising a pitch adjustment system configured to change a pitch of said at least one blade to reduce the load imbalance.

12. A method of operating a wind turbine including a rotor, a plurality of blades coupled to the rotor, and an active flow control system at least partially defined within each of the plurality of blades, said method comprising:
operating the active flow control system in a first mode;
obtaining a signal from a sensor that indicates a load imbalance on the rotor; and
changing an operation of the active flow control system from the first mode to a second mode based on the signal, the second mode configured to reduce the load imbalance on the rotor.

13. A method in accordance with claim 12, wherein obtaining a signal that indicates a load imbalance comprises obtaining a measurement of a bending moment of the rotor.

14. A method in accordance with claim 13 wherein operating the active flow control system in a second mode comprises operating the active flow control to compensate for the bending moment of the rotor.

15. A method in accordance with claim 12 wherein operating the active flow control system in a first mode comprises operating the active flow control system to have a first distribution of air within the active flow control system.

16. A method in accordance with claim 15 wherein operating the active flow control system in a second mode comprises operating the active flow control system to have a second distribution of air that is different than the first distribution of air.

17. A method in accordance with claim 12 further comprising changing a pitch of at least one blade of the plurality of blades to reduce the load imbalance.

18. A method in accordance with claim 17 wherein:
changing an operation of the active flow control system comprises changing the operation of the active flow control system at a first rate; and
changing a pitch of at least one blade comprises changing the pitch at a second rate that is different than the first rate.

19. A method in accordance with claim 12 wherein:
obtaining a signal comprises substantially continuously obtaining the signal; and
changing an operation of the active flow control system from the first mode to a second mode comprises iterative changing the operation of the flow control system as the signal is substantially continuously obtained.

20. A method in accordance with claim 12 further comprising offsetting a pitch of each blade of the plurality of blades based on a reference mark of each blade.
